(19) United States
(12) Patent Application Publication
(10) Pub. No.: US 2022/0242099 A1
(43) Pub. Date: Aug. 4, 2022

(54) MANUFACTURING METHOD OF SHEET-LIKE CONDUCTIVE MEMBER, AND SHEET-LIKE CONDUCTIVE MEMBER

(71) Applicant: LINTEC CORPORATION, Tokyo (JP)

(72) Inventors: Takashi MORIOKA, Tokyo (JP); Masaharu ITO, Tokyo (JP)

(21) Appl. No.: 17/165,727

(22) Filed: Feb. 2, 2021

(51) Int. Cl. B32B 27/08; B32B 27/10; B32B 27/20; B32B 27/22; B32B 27/24; B32B 27/26; B32B 37/12; B32B 15/082; B32B 15/085; B32B 15/088; B32B 15/09; B32B 15/092; B32B 15/095; B32B 7/12; B32B 3/18; H01B 1/02; H01B 1/04

(52) U.S. Cl. CPC B32B 27/08; B82Y 30/00; B32B 27/20; B32B 27/22; B32B 27/24; B32B 27/26; B32B 37/1207; B32B 15/082; B32B 15/085; B32B 15/088; B32B 15/09; B32B 15/092; B32B 15/095; B32B 7/12; B32B 3/18; H01B 1/02; H01B 1/04; B32B 2037/1253; B32B 2307/202; B32B 2307/30; B32B 2250/24; B32B 2260/028; B32B 2260/046; B32B 2274/00; B32B 27/10

(57) ABSTRACT

A manufacturing method of a sheet-shaped conductive member includes: providing a pseudo sheet structure to a first film, the pseudo sheet structure including a plurality of conductive linear bodies arranged at an interval therebetween, the first film including a process film and a first resin layer; attaching a second film including a second resin layer to the first film with the second resin layer in contact with the pseudo sheet structure; and drying or curing at least one of the first resin layer or the second resin layer.

### TECHNICAL FIELD

The present invention relates to a manufacturing method of a sheet-shaped conductive member, and a sheet-shaped conductive member.

### BACKGROUND ART

A sheet-shaped conductive member (hereinafter also referred to as a “conductive sheet”) having a pseudo sheet structure in which a plurality of conductive linear bodies are arranged at an interval therebetween may be applied to components/materials of various articles such as a heat-generating body of a heat-generating device, a material for a heating textile or a display protection film (anti-shatter film).

For instance, Patent Literature 1 (International Publication No. WO 2017/086395) describes a conductive sheet having a pseudo sheet structure in which a plurality of linear bodies extending in one direction are arranged at an interval therebetween.

This conductive sheet is required to be thin in thickness depending on usage. Meanwhile, in the conductive sheet of Patent Literature 1, the pseudo sheet structure is formed on a base material. Since the base material needs to have a certain thickness in a manufacturing process of the conductive sheet, there is a limit to thinning of the thickness.

### SUMMARY OF THE INVENTION

An object of the invention is to provide a manufacturing method of a sheet-shaped conductive member capable of efficiently manufacturing a sheet-shaped conductive member having a sufficiently thin thickness and a freestanding property, and a sheet-shaped conductive member.

According to an aspect of the invention, a manufacturing method of a sheet-shaped conductive member includes: providing a pseudo sheet structure to a first film, the pseudo sheet structure including a plurality of conductive linear bodies arranged at an interval therebetween, the first film including a process film and a first resin layer; attaching a second film including a second resin layer to the first film with the second resin layer in contact with the pseudo sheet structure; and drying or curing at least one of the first resin layer or the second resin layer.

It is preferable that the manufacturing method according to the above aspect of the invention further includes attaching electrodes to the pseudo sheet structure.

In the manufacturing method according to the above aspect of the invention, the second film further includes a process film.

The manufacturing method according to the above aspect of the invention further includes releasing the process film from at least one of the dried or cured first resin layer or second resin layer.

In the manufacturing method according to the above aspect of the invention, a release force of the process film is preferably in a range from 5 mN/100 mm to 2000 mN/100 mm.

In the manufacturing method according to the above aspect of the invention, at least one of the first resin layer or the second resin layer is preferably energy-ray-curable.

In the manufacturing method according to the above aspect of the invention, both of the first resin layer and the second resin layer are preferably energy-ray-curable.

In the manufacturing method according to the above aspect of the invention, a total thickness of a thickness of the first resin layer and a thickness of the second resin layer is preferably in a range from 7 μm to 500 μm.

According to another aspect of the invention, a sheet-shaped conductive member includes: a first resin layer; a second resin layer; and a pseudo sheet structure interposed between the first resin layer and the second resin layer and including a plurality of conductive linear bodies arranged at an interval therebetween, in which a thickness of the sheet-shaped conductive member is in a range from 7 μm to 200 μm, and at least one of the first resin layer or the second resin layer has a storage modulus in a range from 5×10⁷ Pa to 5.0×10¹⁰ Pa at a temperature of 25 degrees C.

According to the above aspects of the invention, a method of efficiently manufacturing a sheet-shaped conductive member having a sufficiently thin thickness and a freestanding property, and a sheet-shaped conductive member can be provided.

### BRIEF DESCRIPTION OF DRAWING(S)

FIGS. 1A to 1E are illustrations for explaining a manufacturing method of a sheet-shaped conductive member according to a first exemplary embodiment of the invention.

FIG. 2 is a cross sectional view of a cross section taken along a line II-II in FIG. 1.

FIGS. 3A to 3E are illustrations for explaining a manufacturing method of a sheet-shaped conductive member according to a second exemplary embodiment of the invention.

FIGS. 4A to 4E are illustrations for explaining a manufacturing method of a sheet-shaped conductive member according to a third exemplary embodiment of the invention.

### DESCRIPTION OF EMBODIMENT(S)

### First Exemplary Embodiment

Description will be made below on the invention with reference to the attached drawings with exemplary embodiments cited as an example. The invention is not limited to the contents of the exemplary embodiments. It should be noted that some parts are shown on an enlarged scale or a reduced scale in the drawings for the convenience of explanation.

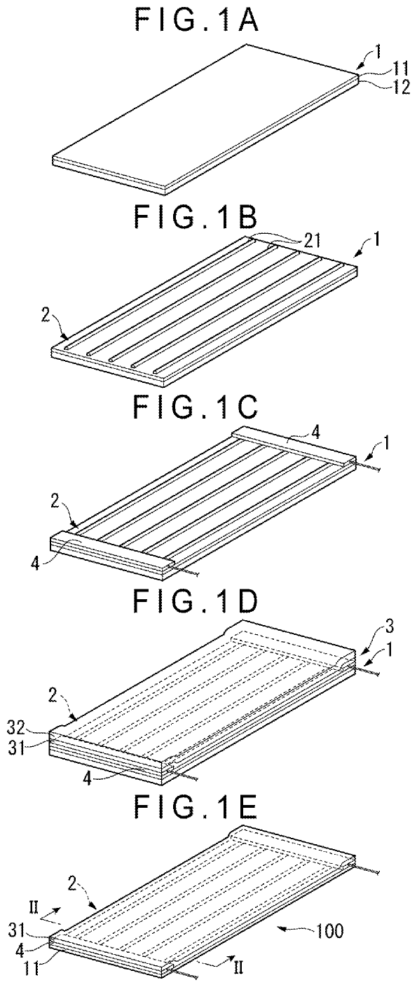

A manufacturing method of a sheet-shaped conductive member 100 in the first exemplary embodiment includes: providing a pseudo sheet structure 2 including a plurality of conductive linear bodies 21 arranged at an interval therebetween as shown in FIG. 1B on a first film 1 including a process film 12 and a first resin layer 11 shown in FIG. 1A (hereinafter, also referred to as a “pseudo sheet structure forming step”); attaching electrodes 4 to the pseudo sheet structure 2 as shown in FIG. 1C (hereinafter, also referred to as a “electrode attaching step”); attaching a second film 3 including a process film 32 and a second resin layer 31 to the first film 1 with the second resin layer 31 in contact with the pseudo sheet structure 2 as shown in FIG. 1D (hereinafter, also referred to as a “second resin layer attaching step”); curing at least one of the first resin layer 11 or the second resin layer 31 (hereinafter, also referred to as a “curing step”); and releasing the at least one of the process film 12 or the process film 32 from the corresponding one(s) of the cured first resin layer 11 and second resin layer 31 as shown in FIG. 1E (hereinafter, also referred to as a “process film release step”).

Firstly, the first resin layer 11, the second resin layer 31, the pseudo sheet structure 2, the process films 12 and 32, and the electrodes 4 used for the manufacturing method of the sheet-shaped conductive member 100 according to the first exemplary embodiment will be described.

### First Resin Layer and Second Resin Layer

The first resin layer 11 and the second resin layer 31 are layers containing a resin. The first resin layer 11 is preferably a layer containing an adhesive agent. When forming the pseudo sheet structure 2 on the first film 1, the adhesive agent facilitates attaching the conductive linear bodies 21 to the first resin layer 11.

At least one of the first resin layer 11 or the second resin layer 31 is formed of a dryable or curable resin. Drying or curing of the resin layer can impart a freestanding property to the sheet-shaped conductive member 100. Moreover, a hardness enough for protecting the pseudo sheet structure 2 is imparted to the first resin layer 11 and the second resin layer 31. Accordingly, the first resin layer 11 and the second resin layer 31 also function as a protection film. Further, the cured or dried first resin layer 11 and second resin layer 31 exhibit impact resistance, so that the first resin layer 11 and the second resin layer 31 can be prevented from being deformed by impact.

It is preferable that at least one of the first resin layer 11 or the second resin layer 31 is curable with an energy ray such as an ultraviolet ray, a visible energy ray, an infrared ray, or an electron ray in terms of an easy curability in a short time. It should be noted that “curing with an energy ray” includes thermosetting by energy-ray heating. It is more preferable that both of the first resin layer 11 and the second resin layer 31 are energy-ray-curable.

Examples of the adhesive agent in the first resin layer 11 and the second resin layer 31 include: a thermosetting adhesive agent that is curable by heat; a so-called heat-seal adhesive agent that is bondable by heat; and an adhesive agent that exhibits stickiness when wetted. However, in terms of easy application, the first resin layer 11 and the second resin layer 31 are preferably energy-ray-curable. An energy-ray-curable resin is exemplified by a compound having at least one polymerizable double bond in a molecule, preferably an acrylate compound having a (meth)acryloyl group.

Examples of the acrylate compound include: chain aliphatic skeleton-containing (meth)acrylates (e.g., dicyclopentadiene diacrylate, trimethylol propane tri(meth)acrylate, tetramethylol methanetetra(meth)acrylate, pentaerythritol tri(meth)acrylate, pentaerythritol tetra(meth)acrylate, dipentaerythritol monohydroxy penta(meth)acrylate, dipentaerythritol hexa(meth)acrylate, 1,4-butylene glycol di(meth)acrylate, and 1,6-hexanediol di(meth)acrylate); cyclic aliphatic skeleton-containing (meth)acrylates (e.g., dicyclopentanyl di(meth)acrylate); polyalkylene glycol(meth)acrylates (polyethyleneglycol di(meth)acrylate); oligoester (meth)acrylate; urethane (meth)acrylate oligomer; epoxy-modified (meth)acrylate; polyether (meth)acrylates other than the above polyalkylene glycol (meth)acrylates; and itaconic acid oligomer.

A weight average molecular weight (Mw) of the energy-ray-curable resin is preferably in a range from 100 to 30000, more preferably from 300 to 10000.

Only one kind or two or more kinds of the energy-ray-curable resins may be contained in the adhesive agent composition. When two or more kinds of the energy-ray-curable resins are contained, a combination and a ratio of the energy-ray-curable resins are selected as needed. Further, the energy-ray-curable resin(s) may be combined with a thermoplastic resin described later. A combination and a ratio of the energy-ray-curable resin(s) and thermoplastic resin are selected as needed.

The first resin layer 11 and the second resin layer 31 may be a sticky agent layer formed of a sticky agent (a pressure-sensitive adhesive agent). The sticky agent in the sticky agent layer is not particularly limited. Examples of the sticky agent include an acrylic sticky agent, a urethane sticky agent, a rubber sticky agent, a polyester sticky agent, a silicone sticky agent, and a polyvinyl ether sticky agent. Among the above, the sticky agent is preferably at least one selected from the group consisting of an acrylic sticky agent, a urethane sticky agent, and a rubber sticky agent, more preferably an acrylic sticky agent.

Examples of an acrylic sticky agent include a polymer including a constituent unit derived from alkyl (meth)acrylate having a linear alkyl group or a branched alkyl group (i.e., a polymer with at least alkyl (meth)acrylate polymerized) and an acrylic polymer including a constituent unit derived from a (meth)acrylate with a ring structure (i.e., a polymer with at least a (meth)acrylate with a ring structure polymerized). Herein, the “(meth)acrylate” is used as a term referring to both “acrylate” and “methacrylate” and the same applies to other similar terms.

In a case where the acrylic polymer is a copolymer, a manner of copolymerization is not particularly limited. The acrylic copolymer may be any one of a block copolymer, a random copolymer, and a graft copolymer.

Among the above, an acrylic copolymer including a constituent unit (a1) derived from alkyl (meth)acrylate (a1′) having a chain alkyl group having 1 to 20 carbon atoms (hereinafter, also referred to as “monomer component (a1′)”) and a constituent unit (a2) derived from a functional-group-containing monomer (a2′) (hereinafter, also referred to as “monomer component (a2′)”) is preferable as the acrylic sticky agent.

It should be noted that the acrylic copolymer may further include a constituent unit (a3) derived from a monomer component (a3′) other than the monomer component (a1′) and the monomer component (a2′).

In terms of an improvement in adhesion properties, the number of the carbon atoms of the chain alkyl group of the monomer component (a1′) is preferably in a range from 1 to 12, more preferably in a range from 4 to 8, further preferably in a range from 4 to 6. Examples of the monomer component (a1′) include methyl (meth)acrylate, ethyl (meth)acrylate, propyl (meth)acrylate, n-butyl (meth)acrylate, 2-ethylhexyl (meth)acrylate, lauryl (meth)acrylate, tridecyl (meth)acrylate, and stearyl (meth)acrylate. Among these monomer components (a1′), butyl (meth)acrylate and 2-ethylhexyl (meth)acrylate are preferable and butyl (meth)acrylate is more preferable.

The content of the constituent unit (a1) relative to all the constituent units of the acrylic copolymer (100 mass%) is preferably in a range from 50 mass% to 99.5 mass%, more preferably in a range from 55 mass% to 99 mass%, further preferably in a range from 60 mass% to 97 mass%, particularly preferably in a range from 65 mass% to 95 mass%.

Examples of the monomer component (a2′) include a hydroxy-group-containing monomer, a carboxy-group-containing monomer, an epoxy-group-containing monomer, an amino-group-containing monomer, a cyano-group-containing monomer, a keto-group-containing monomer, and an alkoxysilyl-group-containing monomer. Among these monomer components (a2′), a hydroxy-group-containing monomer and a carboxy-group-containing monomer are preferable.

Examples of a hydroxy-group-containing monomer include 2-hydroxyethyl (meth)acrylate, 2-hydroxypropyl (meth)acrylate, 2-hydroxybutyl (meth)acrylate, 3-hydroxybutyl (meth)acrylate, and 4-hydroxybutyl (meth)acrylate, among which 2-hydroxyethyl (meth)acrylate is preferable.

Examples of a carboxy-group-containing monomer include a (meth)acrylic acid, a maleic acid, a fumaric acid, and an itaconic acid, among which a (meth)acrylic acid is preferable.

Examples of an epoxy-group-containing monomer include glycidyl (meth)acrylate.

Examples of an amino-group-containing monomer include diaminoethyl (meth)acrylate.

Examples of a cyano-group-containing monomer include acrylonitrile.

The content of the constituent unit (a2) relative to all the constituent units of the acrylic copolymer (100 mass%) is preferably in a range from 0.1 mass% to 50 mass%, more preferably in a range from 0.5 mass% to 40 mass%, further preferably in a range from 1.0 mass% to 30 mass%, particularly preferably in a range from 1.5 mass% to 20 mass%.

Examples of the monomer component (a3′) include a (meth)acrylate having a ring structure (e.g., cyclohexyl (meth)acrylate, benzil (meth)acrylate, isobornyl (meth)acrylate, dicyclopentanyl (meth)acrylate, dicyclopentenyl (meth)acrylate, dicyclopentenyloxyethyl (meth)acrylate, imide (meth)acrylate, and acryloylmorpholine), vinyl acetate, and styrene.

The content of the constituent unit (a3) relative to all the constituent units of the acrylic copolymer (100 mass%) is preferably in a range from 0 mass% to 40 mass%, more preferably in a range from 0 mass% to 30 mass%, further preferably in a range from 0 mass% to 25 mass%, particularly preferably in a range from 0 mass% to 20 mass%.

It should be noted that the above monomer components (a1′) may be used alone or two or more thereof may be used in combination, the above monomer components (a2′) may be used alone or two or more thereof may be used in combination, and the above monomer components (a3′) may be used alone or two or more thereof may be used in combination.

The acrylic copolymer may be cross-linked by a cross-linker. Examples of the cross-linker include a known epoxy cross-linker, isocyanate cross-linker, aziridine cross-linker, and metal chelate cross-linker. In cross-linking the acrylic copolymer, a functional group derived from the monomer component (a2′) can be used as a cross-link point to react with the cross-linker.

The first resin layer 11 and the second resin layer 31 may further contain an energy-ray curable component in addition to the above sticky agent.

Examples of the energy-ray curable component include, in a case where the energy ray is, for instance, an ultraviolet ray, a compound having two or more UV-polymerizable functional groups in one molecule, such as a multifunctional (meth)acrylate compound.

Further, in a case where the acrylic sticky agent is used as the sticky agent, a compound having a functional group reactive with the functional group derived from the monomer component (a2′) of the acrylic copolymer and an energy-ray polymerizable functional group in one molecule as the energy-ray curable component. Reaction between the functional group of the compound and the functional group derived from the monomer component (a2′) of the acrylic copolymer enables a side chain of the acrylic copolymer to be polymerizable by energy ray irradiation. Even in a case where the sticky agent is not the acrylic sticky agent, a component with an energy-ray polymerizable side chain may likewise be used as a copolymer component other than the copolymer that serves as the sticky agent.

When at least one of the first resin layer 11 or the second resin layer 31 is energy-ray curable, the sticky agent layer preferably contains a photopolymerization initiator. The photopolymerization initiator enables increasing a speed at which the sticky agent layer is cured by energy ray irradiation.

The thermosetting resin used as the first resin layer 11 and the second resin layer 31 is not particularly limited. Specific examples of the thermosetting resin include an epoxy resin, phenol resin, melamine resin, urea resin, polyester resin, urethane resin, acrylic resin, benzoxazine resin, phenoxy resin, amine compound and acid anhydride compound.One of the thermosetting resins may be used alone, or two or more thereof may be used in combination. Among the above examples, in terms of suitability for curing with an imidazole curing catalyst, it is preferable to use at least one selected from the group consisting of an epoxy resin, phenol resin, melamine resin, urea resin, amine compound and acid anhydride compound. Particularly, in terms of exhibiting an excellent curability, it is preferable to use a mixture of an epoxy resin, phenol resin, a mixture thereof, or a mixture of an epoxy resin and at least one selected from the group consisting of a phenol resin, melamine resin, urea resin, amine compound and acid anhydride compound.

A moisture-curable resin used as the first resin layer 11 and the second resin layer 31 is not particularly limited. Examples of the moisture-curable resin include a urethane resin from which an isocyanate group is generated by moisture, and a modified silicone resin.

When the energy-ray-curable resin or the thermosetting resin is used, a photopolymerization initiator or a thermal polymerization initiator is preferably used. By using the photopolymerization initiator or the thermal polymerization initiator, a cross-linking structure is formed, thereby enabling to more firmly protect the pseudo sheet structure 2.

Examples of the photopolymerization initiator include benzophenone, acetophenone, benzoin, benzoinmethylether, benzoinethylether, benzoinisopropylether, benzoinisobutylether, benzoin benzoic acid, benzoin methyl benzoate, benzoin dimethylketal, 2,4-diethyl thioxanthone, 1-hydroxy cyclohexylphenylketone, benzyl diphenyl sulfide, tetramethylthiuram monosulfide, azobisisobutyronitrile, 2-chloroanthraquinone, diphenyl(2,4,6-trimethylbenzoyl)phosphine oxide, and bis(2,4,6-trimethylbenzoyl)-phenyl -phosphine oxide.

Examples of the thermal polymerization initiator include hydrogen peroxide, peroxydisulfuric acid salts (e.g., ammonium peroxodisulfate, sodium peroxodisulfate, and potassium peroxodisulfate), azo compounds (e.g., 2,2′-azobis( 2-amidinopropane)dihydrochloride, 4,4′-azobis(4-cyanovaleric acid), 2,2′-azobisiosbutyronitrile, and 2,2′-azobis(4-methoxy-2,4-dimethylvaleronitrile)), and organic peroxides (e.g., benzoyl peroxide, lauroyl peroxide, peracetic acid, persuccinic acid, di-t-butyl peroxide, t-butyl hydroperoxide, and cumene hydroperoxide).

One of the polymerization initiators may be used alone, or two or more thereof may be used in combination.

When the polymerization initiator is used for forming a cross-linking structure, the content of the polymerization initiator is preferably in a range from 0.1 parts by mass to 100 parts by mass, more preferably in a range from 1 parts by mass to 100 parts by mass, particularly preferably in a range from 1 parts by mass to 10 parts by mass, with respect to 100 parts by mass of the energy-ray-curable resin or the thermosetting resin.

The first resin layer 11 and the second resin layer 31 may contain an inorganic filler. With the inorganic filler contained, a hardness of the cured first resin layer 11 and second resin layer 31 can be further improved. In addition, a heat conductivity of the first resin layer 11 and the second resin layer 31 is improved.

Examples of the inorganic filler include inorganic powder (e.g., powders of silica, alumina, talc, calcium carbonate, titanium white, colcothar, silicon carbide, and boron nitride), beads of spheroidized inorganic powder, single crystal fiber, and glass fiber. Among the above, a silica filler and an alumina filler are preferable as the inorganic filler. One of the inorganic fillers may be used alone or two or more thereof may be used in combination.

Other components may be contained in the first resin layer 11 and the second resin layer 31. Examples of other components include known additives such as an organic solvent, a flame retardant, a tackifier, an ultraviolet absorber, an antioxidant, a preservative, an antifungal agent, a plasticizer, a defoamer, and a wettability modifier.

A thickness of each of the first resin layer 11 and the second resin layer 31 is determined as needed depending on an intended use of the sheet-shaped conductive member 100. In order that the sheet-shaped conductive member 100 is thinner and freestanding, a total thickness of the thickness of the first resin layer 11 and the thickness of the second resin layer 31 is preferably in a range from 7 μm to 500 μm, more preferably in a range from 10 μm to 200 μm, further preferably in a range from 10 μm to 100 μm, particularly preferably in a range from 10 μm to 50 μm.

### Pseudo Sheet Structure

In the pseudo sheet structure 2, a plurality of unidirectionally extending conductive linear bodies 21 are arranged at an interval therebetween. In a plan view of the sheet-shaped conductive member 100, the conductive linear bodies 21 are in a linear form or waveform. Specifically, the conductive linear bodies 21 may be in, for instance, a sinusoidal, rectangular, triangular or sawtooth waveform. In other words, in the pseudo sheet structure 2, the plurality of conductive linear bodies 21 are aligned at equal intervals in a direction orthogonal to the axial direction of the conductive linear bodies 21.

The pseudo sheet structure 2 with the above arrangement can prevent the conductive linear bodies 21 from being cut when the sheet-shaped conductive member 100 is stretched in the axial direction of the conductive linear bodies 21. It should be noted that the conductive linear bodies 21 are not cut even if the sheet-shaped conductive member 100 is stretched in the direction orthogonal to the axial direction of the conductive linear bodies 21. Accordingly, the sheet-shaped conductive member 100 has sufficient stretchability.

A volume resistivity R of the conductive linear body 21 is preferably in a range from 1.0×10⁻⁹Ω·m to 1.0×10⁻³Ω·m, more preferably in a range from 1.0×10⁻⁸Ω·m to 1.0×10⁻⁴Ω·m. At the volume resistivity R of the conductive linear body 21 in the above range, a surface resistance of the pseudo sheet structure 2 is likely to decrease.

A method of measuring the volume resistivity R of the conductive linear body 21 is as follows. A silver paste is applied to both ends of the conductive linear body 21 and a resistance of a portion at a length of 40 mm from each end is measured to calculate a resistance value of the conductive linear body 21. Further, the resistance value is multiplied by a cross sectional area (unit: m²) of the conductive linear body 21 and the obtained value is divided by the measured length (0.04 m) to calculate the volume resistivity R of the conductive linear body 21.

A shape of the cross section of the conductive linear body 21 is not particularly limited and may be a polygonal shape, a flat shape, an oval shape, a circular shape, or the like. An oval shape or a circular shape is preferable in terms of, for instance, affinity to the first resin layer 11.

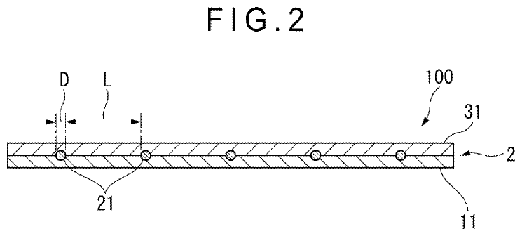

In a case where the cross section of the conductive linear body 21 is in a circular shape, a diameter D of the conductive linear body 21 (see FIG. 2) is preferably in a range from 5 μm to 75 μm. In terms of a reduction in a rise in sheet resistance and an improvement in heat generation efficiency and anti-insulation/breakage properties in a case where the sheet-shaped conductive member 100 is used as a heat-generating body, the diameter D of the conductive linear body 21 is more preferably in a range from 8 μm to 60 μm, further preferably in a range from 12 μm to 40 μm.

In a case where the cross section of the conductive linear body 21 is in an oval shape, it is preferable that a long diameter is in a range similar to that of the above diameter D.

The diameter D of the conductive linear body 21 is an average value of results of measuring the diameter of the conductive linear body 21 at five spots selected at random by observing the conductive linear body 21 of the pseudo sheet structure 2 with a digital microscope.

An interval L between the conductive linear bodies 21 (see FIG. 2) is preferably in a range from 0.3 mm to 12.0 mm, more preferably in a range from 0.5 mm to 10.0 mm, further preferably in a range from 0.8 mm to 7.0 mm.

With the interval between the conductive linear bodies 21 being within the above range, the conductive linear bodies are dense to some extent, allowing for keeping the resistance of the pseudo sheet structure low to improve a function of the sheet-shaped conductive member 100 such as equalization of distribution of temperature rise in a case where the sheet-shaped conductive member 100 is used as a heat-generating body.

For the interval L between the conductive linear bodies 21, an interval between adjacent two of the conductive linear bodies 21 is measured by observing the conductive linear bodies 21 of the pseudo sheet structure 2 with a digital microscope.

It should be noted that the interval between adjacent two of the conductive linear bodies 21 is a length along a direction in which the conductive linear bodies 21 are arranged, that is, a length between facing portions of the two conductive linear bodies 21 (see FIG. 2). In a case where the conductive linear bodies 21 are arranged at irregular intervals, the interval L is an average value of the intervals between all the adjacent ones of the conductive linear bodies 21. However, in terms of easy control of the value of the interval L, or the like, the conductive linear bodies 21 are preferably arranged substantially at regular intervals in the pseudo sheet structure 2, more preferably arranged at regular intervals.

The conductive linear bodies 21 may be linear bodies including metal wires (hereinafter also referred to as “metal wire linear bodies”), but are not particularly limited thereto. Since the metal wires have a high thermal conductivity, a high electrical conductivity, an excellent handleability, and versatility, the application of the metal wire linear bodies as the conductive linear bodies 21 facilitates to improve the light transmittance while reducing the resistance value of the pseudo sheet structure 2. The application of the sheet-shaped conductive member 100 (pseudo sheet structure 2 ) as the heat-generating body facilitates achieving prompt heat generation. As described above, linear bodies each having a small diameter are likely to be obtained.

Examples of the conductive linear bodies 21 include linear bodies including carbon nanotubes and linear bodies in a form of conductively coated strings, in addition to the metal wire linear bodies.

The carbon nanotube linear body is obtained by, for instance, drawing, from an end of a carbon nanotube forest (which is a grown form provided by causing a plurality of carbon nanotubes to grow on a substrate, being oriented in a vertical direction relative to the substrate, and is also referred to as “array”), the carbon nanotubes into a sheet form, and spinning a bundle of the carbon nanotubes after drawn carbon nanotube sheets are bundled. In such a producing method, a ribbon-shaped carbon nanotube linear body is obtained when the bundle of the carbon nanotubes is spun without being twisted, and a thread-shaped linear body is obtained when the bundle of the carbon nanotubes is spun while being twisted. The ribbon-shaped carbon nanotube linear body is a linear body without a structure where the carbon nanotubes are twisted. Alternatively, the carbon nanotube linear body can be obtained by, for instance, spinning from a dispersion liquid of carbon nanotubes. The production of the carbon nanotube linear body by spinning can be performed by, for instance, a method disclosed in U.S. Patent Application Publication No. 2013/0251619 (JP 2012-126635 A). In terms of achieving uniformity in diameter of the carbon nanotube linear bodies, it is desirable that string-shaped carbon nanotube linear bodies are used. In terms of obtaining carbon nanotube linear bodies with a high purity, it is preferable that the string-shaped carbon nanotube linear bodies are obtained by twisting the carbon nanotube sheets. The carbon nanotube linear bodies may each be a linear body provided by weaving two or more carbon nanotube linear bodies together. Alternatively, the carbon nanotube linear bodies may each be a linear body provided by combining a carbon nanotube and another conductive material (hereinafter, also referred to as “composite linear body”).

Examples of the composite linear bodies include: (1) a composite linear body obtained by depositing an elemental metal or metal alloy on a surface of a forest, sheets or a bundle of carbon nanotubes, or a spun linear body through a method such as vapor deposition, ion plating, sputtering or wet plating in the process of manufacturing a carbon nanotube linear body obtained by drawing carbon nanotubes from an end of the carbon nanotube forest to form the sheets, bundling the drawn carbon nanotube sheets and then spinning the bundle of the carbon nanotubes; (2) a composite linear body in which a bundle of carbon nanotubes is spun with a linear body or composite linear body of an elemental metal or metal alloy; and (3) a composite linear body in which a carbon nanotube linear body or a composite linear body is woven with a linear body or composite linear body of an elemental metal or metal alloy. It should be noted that regarding the composite linear body of (2), a metal may be supported on the carbon nanotubes in spinning the bundle of the carbon nanotubes as the composite linear body of (1). Further, although the composite linear body of (3) is a composite linear body provided by weaving two linear bodies, the composite linear body of (3) may be provided by weaving three or more carbon nanotube linear bodies, linear bodies of an elemental metal, or linear bodies or composite linear bodies of a metal alloy, as long as at least one linear body of an elemental metal, or linear body or composite linear body of a metal alloy is contained.

Examples of the metal for the composite linear body include elemental metals such as gold, silver, copper, iron, aluminum, nickel, chrome, tin, and zinc and alloys containing at least one of these elemental metals (a copper-nickel-phosphorus alloy, a copper-iron-phosphorus-zinc alloy, etc.).

The conductive linear bodies 21 may each be a linear body in a form of a conductively coated string. Examples of the string include strings made of resins such as nylon and polyester by spinning. Examples of the conductive coating include coating films of a metal, a conductive polymer, and a carbon material. The conductive coating can be formed by plating, vapor deposition or the like. The linear body including the conductively coated string can be improved in conductivity of the linear body with flexibility of the string maintained. In other words, a reduction in resistance of the pseudo sheet structure 2 is facilitated.

The conductive linear bodies 21 may each be a linear body including a metal wire. The linear body including the metal wire may be a linear body formed of a single metal wire or a linear body made by spinning a plurality of metal wires.

Examples of the metal wire include wires containing metals, such as copper, aluminum, tungsten, iron, molybdenum, nickel, titanium, silver, and gold, or alloys containing two or more metals (e.g., steels such as stainless steel and carbon steel, brass, phosphor bronze, zirconium-copper alloy, beryllium copper, iron nickel, Nichrome, nickel titanium, KANTHAL®, HASTELLOY®, and rhenium tungsten). The metal wire may be plated with tin, zinc, silver, nickel, chrome, a nickel-chrome alloy, solder or the like. The surface of the metal wire may be coated with a later-described carbon material or a polymer. In particular, a wire containing one or more metals selected from among tungsten and molybdenum and alloys containing tungsten and molybdenum is preferable in terms of providing the conductive linear bodies 21 with a low volume resistivity.

The examples of the metal wire also include a metal wire coated with a carbon material. Coating the metal wire with the carbon material serves to easily make the presence of the metal wire less noticeable with a metallic luster reduced. In addition, coating the metal wire with the carbon material also serves to reduce metal corrosion.

Examples of the carbon material for coating the metal wire include amorphous carbon (e.g., carbon black, activated carbon, hard carbon, soft carbon, mesoporous carbon, and carbon fiber), graphite, fullerene, graphene, and carbon nanotube.

### Process Film

The process films 12 and 32 are required at the time of manufacturing the sheet-shaped conductive member 100, but become unnecessary and releasable after the sheet-shaped conductive member 100 is manufactured. The process films 12 and 32 each usually include a release base material and a release layer.

Examples of the release base material include a paper base, a laminated paper including a paper base or the like with a thermoplastic resin (e.g., polyethylene) laminated thereon, and a plastic film. Examples of the paper base include glassine paper, coated paper, and cast-coated paper. Examples of the plastic film include a polyester film (e.g., polyethylene terephthalate, polybutylene terephthalate, and polyethylene naphthalate) and a polyolefin film (e.g., polypropylene and polyethylene).Examples of the release agent include an olefin resin, a rubber elastomer (e.g., a butadiene resin and an isoprene resin), a long-chain alkyl resin, an alkyd resin, a fluorine resin, and a silicone resin.

The release layer is not particularly limited. For instance, it is preferable that the release layer is formed by applying a release agent onto a release base material in terms of easy handling. Further, the release layer may be provided only on one surface of the release base material or may be provided on both surfaces of the release base material.

In a case where a plastic film is used as the release base material, a thickness of the plastic film is preferably in a range from 4 μm to 200 μm, more preferably in a range from 10 μm to 125 μm.

A thickness of the release layer is not particularly limited. In a case where the release layer is formed by applying a solution containing the release agent, the thickness of the release layer is preferably in a range from 0.01 μm to 2.0 μm, more preferably in a range from 0.03 μm to 1.0 μm.

### Electrodes

Electrodes 4 are used for supplying electric current to the conductive linear bodies 21. The electrodes 4 are disposed in electrical connection on both ends of each of the conductive linear bodies 21.

The electrodes are preferably belt-shaped, since the belt-shaped electrodes can ensure a favorable contact area with even the conductive linear bodies 21 having a small diameter. A conductive foil or plate is usable as the electrodes. Each of the electrodes in a form of a conductive foil or plate preferably has a through hole. Since having the through hole, the electrodes are improved in adhesion to the first resin layer and the second resin layer, thereby providing a favorable connection between the conductive linear bodies 21 and the electrodes. The through hole can be formed by expanding or punching.

As the electrodes 4, specifically, a foil or plate made of a metal such as gold, silver, copper, nickel, iron, aluminum, tungsten, molybdenum, or titanium is applicable. In addition, as the electrodes, a foil or plate made of an alloy of the above metals or other metals, or stainless steel containing non-metal element, carbon steel, brass, phosphor bronze, zirconium-copper alloy, beryllium copper, iron nickel, Nichrome, nickel titanium, KANTHAL®, HASTELLOY®, and rhenium tungsten may be applied, or a belt-shaped body containing a carbon material such as carbon nanotubes, carbon nanofibers or graphene may be applied. Alternatively, the electrodes may be laminated with a plastic film to form a laminate.

Alternatively, the electrodes 4 may be electrodes obtained by solidifying a liquid conductive material (i.e., electrodes formed of a solidified substance of a liquid conductive material) in order to ensure a favorable contact state between the conductive linear bodies 21 and the electrodes 4. The liquid conductive material is typified by a conductive paste. The conductive paste is exemplified by a paste in which metal particles or carbon particles are dispersed in a binder resin and/or an organic solvent. Examples of the metal particles include metal particles of gold, silver, copper, and nickel. Examples of the binder resin include known resins such as a polyester resin, polyurethane resin, epoxy resin, and phenol resin.

In addition to the conductive paste, solder, a conductive ink and the like may be applied as the liquid conductive material.

The conductive foil or plate and the liquid conductive material may be used in combination for the electrodes 4. The liquid conductive material may be applied to the pseudo sheet structure 2 and subsequently the conductive foil or plate may be attached thereto. Alternatively, the conductive foil or plate having a through hole may be attached to the pseudo sheet structure 2 and subsequently the liquid conductive material may be applied thereto.

The electrodes are more favorably connected by using the conductive foil or plate and the liquid conductive material in combination.

Alternatively, the conductive linear bodies 21 that are closely arranged may be used as the electrodes 4.

A ratio of resistance values between the electrodes 4 and the pseudo sheet structure 2 is preferably in a range from 0.0001 to 0.3, more preferably in a range from 0.0005 to 0.1. The ratio of the resistance values between the electrodes 4 and the pseudo sheet structure 2 can be calculated from “the resistance value of the electrodes 4/the resistance value of the pseudo sheet structure 2. ” At the ratio of the resistance values falling within this range, when the sheet-shaped conductive member 100 is used as a heat-generating body, abnormal heat generation at the electrodes are suppressed. When the pseudo sheet structure 2 is used as a film heater, only the pseudo sheet structure 2 generates heat, so that a film heater having a favorable heat generation efficiency can be obtained.

The respective resistance values of the electrodes 4 and the pseudo sheet structure 2 can be measured with a tester. Firstly, the resistance value of the electrodes 4 is measured and the resistance value of the pseudo sheet structure 2 attached with the electrodes 4 is measured. Subsequently, the respective resistance values of the electrodes 4 and the pseudo sheet structure 2 are calculated by subtracting the measurement value of the electrodes 4 from the resistance value of the pseudo sheet structure 2 attached with the electrodes.

A thickness of each of the electrodes 4 is preferably in a range from 2 μm to 200 μm, more preferably in a range from 2 μm to 120 μm, particularly preferably in a range from 10 μm to 100 μm. At the thickness of each of the electrodes falling within the above range, the electric conductivity becomes high and the resistance becomes low, so that the resistance value of the electrodes against the pseudo sheet structure is suppressed low. Moreover, a sufficient strength is imparted to the electrodes.

### Pseudo Sheet Structure Forming Step

In a pseudo sheet structure forming step, firstly, the first film 1 including the process film 12 and the first resin layer 11 are prepared as shown in FIG. 1A.

It is preferable to manufacture in advance the first film 1 including the process film 12 and the first resin layer 11. The first film 1 can be manufactured by, for instance, coating a resin composition, which is a raw material of the first resin layer 11, on the process film 12.

In the pseudo sheet structure forming step, next, the pseudo sheet structure 2 in which a plurality of conductive linear bodies 21 as shown in FIG. 1B are arranged at an interval therebetween is provided on the first film 1.

A method of providing the pseudo sheet structure 2 is not particularly limited, but any known method is applicable as needed. For instance, while a drum member (not shown) is rotated with the first resin layer 11 of the first film 1 disposed on an outer circumferential surface of the drum member, the conductive linear bodies 21 are helically wound on the first resin layer 11. A bundle of the helically wound conductive linear bodies 21 is then cut along an axial direction of the drum member. With this operation, the pseudo sheet structure 2 is formed and simultaneously disposed on the first resin layer 11 of the first film 1. Then, the first film 1 on which the pseudo sheet structure 2 is formed is taken off the drum member. According to this method, the interval L between adjacent ones of the conductive linear bodies 21 of the pseudo sheet structure 2 is easily adjusted by, for instance, moving a feeder of the conductive linear bodies 21 along a direction parallel with an axis of the drum member while turning the drum member.

### Electrode Attaching Step

In an electrode attaching step, the electrodes 4 are attached to the pseudo sheet structure 2 as shown in FIG. 1C.

A method of attaching the electrodes 4 is not particularly limited, but any known method is applicable as needed. For instance, the electrodes 4 are disposed on the first resin layer 11 of the first film 1 such that the conductive linear bodies 21 are in contact with the electrodes 4. Subsequently, the electrodes 4 adhere on the first film 1 by thermocompression bonding, whereby the electrodes 4 can be attached to the pseudo sheet structure 2.

Conditions of the thermocompression bonding are not particularly limited, but can be set as needed according to the type of the first resin layer 11.

### Second Resin Layer Attaching Step

In a second resin layer attaching step, firstly, the second film 3 including the process film 32 and the second resin layer 31 are prepared as shown in FIG. 1D.

It is preferable to manufacture in advance the second film 3 including the process film 32 and the second resin layer 31. The second film 3 can be manufactured by the same method as the first film 1.

In the second resin layer attaching step, next, as shown in FIG. 1D, the second film 3 is attached to the first film 1 such that the second resin layer 31 is in contact with the pseudo sheet structure 2.

At this time, when at least one of the first resin layer 11 or the second resin layer 31 contains an adhesive agent, the second film 3 can be easily attached to the first film 1.

### Curing Step

In a curing step, at least one of the first resin layer 11 or the second resin layer 31 is cured.

Conditions of curing are not particularly limited, but can be set as needed according to the type of the resin composition. A case where at least one of the first resin layer 11 or the second resin layer 31 is energy-ray-curable is described as an example as follows. Conditions of curing with an energy ray are different depending on an energy ray used. For instance, in a case where the curing is performed by ultraviolet irradiation, an irradiation amount of the ultraviolet ray is preferably in a range from 10 mJ/cm² to 3,000 mJ/cm² and an irradiation time is preferably in a range from 1 second to 180 seconds.

### Process Film Release Step

In a process film release step, as shown in FIG. 1E, at least one of the process films 12, 32 is released from the corresponding one(s) of the first resin layer 11 and the second resin layer 31. Thus, the sheet-shaped conductive member 100 including the first resin layer 11, the second resin layer 31, and the pseudo sheet structure 2 interposed between the first resin layer 11 and the second resin layer 31 as shown in FIG. 2 can be manufactured.

A method of releasing at least one of the process films 12, 32 is not particularly limited, but any known method is applicable as needed.

Here, a release force required between the process films 12, 32 and the respective resin layers in contact therewith is preferably in a range from 5 mN/100 mm to 2000 mN/100 mm, more preferably in a range from 20 mN/100 mm to 1250 mN/100 mm.

As for the release force for each of the process films 12, 32, for instance, a sample (width: 100 mm, length: 100 mm) including the process films 12, 32 and the respective first resin layer 11 and second resin layer 31 is fixed, and the process films 12, 32 are pulled at a speed of 300 mm/minute in a direction of 180 degrees with a stretch tester, whereby a release force of an interface between the process films 12, 32 and the respective first resin layer 11 and second resin layer 31 can be measured (unit: mN/100 mm).

It is preferable to differentiate the release force between the process film 12 and the first resin layer 11 from the release force between the process film 32 and the second resin layer 31. By providing a difference, only one of the process films can be easily released. The difference of the release force is 20 mN/25 mm or more, preferably 40 mN/25 mm or more, further preferably 80 mN/25 mm or more.

### Sheet-Shaped Conductive Member

The sheet-shaped conductive member 100 according to the exemplary embodiment includes the first resin layer 11, the second resin layer 31, and the pseudo sheet structure 2 interposed between the first resin layer 11 and the second resin layer 31 and provided with the plurality of conductive linear bodies 21 arranged at an interval therebetween. A thickness of the sheet-shaped conductive member 100 is in a range from 7 μm to 200 μm. A storage modulus of the sheet-shaped conductive member 100 at a temperature of 25 degrees C. is in a range from 5.0×10⁷ Pa to 5.0×10¹⁰ Pa.

The sheet-shaped conductive member 100 can be manufactured by the manufacturing method of the sheet-shaped conductive member according to the exemplary embodiment.

By the manufacturing method of the sheet-shaped conductive member according to the exemplary embodiment, the sheet-shaped conductive member 100 that is sufficiently thin in thickness and freestanding can be efficiently manufactured. Specifically, according to the manufacturing method of the sheet-shaped conductive member of the exemplary embodiment, the sheet-shaped conductive member 100 having the thickness of the sheet-shaped conductive member 100 in a range from 7 μm to 200 μm (more preferably from 10 μm to 100 μm, particularly preferably from 10 μm to 50 μm) and the storage modulus of at least one of the first resin layer 11 or the second resin layer 31 at a temperature of 25 degrees C. in a range from 5.0×10⁷ Pa to 5.0×10¹⁰ Pa (more preferably from 1.0×10⁸ Pa to 1.0×10¹⁰ Pa) can be efficiently manufactured. The storage modulus of the dried or cured sheet-shaped conductive member 100 is measured in a tensile mode.

Moreover, at the storage modulus falling within the above range, adhesion (resistance stability) of the sheet-shaped conductive member on the electrodes, heat resistance and impact resistance thereof can be improved.

The storage modulus at the temperature of 25 degrees C. of at least one of the first resin layer 11 or the second resin layer 31 before being dried or cured is preferably in a range from 1.0×10³ Pa to 2.5×10⁵ Pa. The storage modulus before the drying and curing is measured by torsional shearing.

The measurement method of the storage modulus at the temperature of 25 degrees C. is described in detail in the description about Example.

### Effects of First Exemplary Embodiment

The exemplary embodiment can achieve the following effects.

(1) In the first exemplary embodiment, the sheet-shaped conductive member 100 having the thickness in a range from 7 μm to 200 μm and the storage modulus at the temperature of 25 degrees C. in a range from 5.0×10⁷ Pa to 5.0×10¹⁰ Pa is obtained.

(2) In the first exemplary embodiment, each of the electrodes 4 is interposed between the first resin layer 11 and the second resin layer 31. With this arrangement, adhesion between the conductive linear bodies 21 and the electrodes 4 can be improved in the sheet-shaped conductive member 100.

(3) A position of the pseudo sheet structure 2 in the sheet-shaped conductive member 100 can be adjusted by adjusting the thickness of each of the first resin layer 11 and the second resin layer 31. The position of the pseudo sheet structure 2 can be centered, for instance, by equalizing the thickness between the first resin layer 11 and the second resin layer 31.

(4) Since the pseudo sheet structure 2 is covered with the first resin layer 11 and the second resin layer 31, electric leakage can be prevented.

(5) By curing at least one of the first resin layer 11 or the second resin layer 31, the conductive linear bodies 21 can be protected. In a case where one of the first resin layer 11 and the second resin layer 31 is cured, the other thereof can be attached to an adherend as an adhesive layer.

### Second Exemplary Embodiment

Next, description will be made on a second exemplary embodiment of the invention on the basis of the attached drawing.

The second exemplary embodiment is configured the same as the first exemplary embodiment except that the first resin layer 11 and the second resin layer 31 are non-curable layers and the drying step is conducted in place of the curing step. The first resin layer 11, the second resin layer 31 and the drying step are described, and the description of the rest common to the above is omitted.

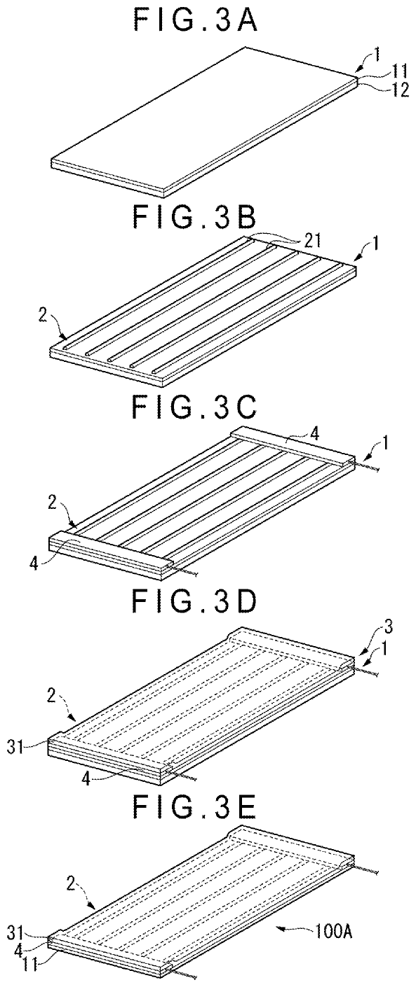

FIGS. 3A to 3E are illustrations for explaining a manufacturing method of a sheet-shaped conductive member according to the second exemplary embodiment.

The first resin layer 11 and the second resin layer 31 used in the second exemplary embodiment are not curable, but may be, for instance, a layer formed of a thermoplastic resin composition. A thermoplastic resin layer can be softened by containing a solvent in the thermoplastic resin composition. With this configuration, when forming the pseudo sheet structure 2 on the first film 1, attachment of the conductive linear bodies 21 to the first resin layer 11 is facilitated. Meanwhile, by volatilizing the solvent in the thermoplastic resin composition, the thermoplastic resin layer can be dried to be solidified. This treatment can impart freestanding property to the sheet-shaped conductive member 100.

It should be noted that one of the first resin layer 11 and the second resin layer 31 may be the same as the corresponding one of the first resin layer 11 and the second resin layer 31 in the first exemplary embodiment.

Examples of the thermoplastic resin include polyethylene, polypropylene, polyvinyl chloride, polystyrene, polyvinyl acetate, polyurethane, polyether, polyethersulfone, polyimide and acrylic resin.

Examples of the solvent include an alcohol solvent, ketone solvent, ester solvent, ether solvent, hydrocarbon solvent, alkyl halide solvent and water.

The first resin layer 11 and the second resin layer 31 used in the second exemplary embodiment may contain other component(s) such as an inorganic filler in the same manner as in the first resin layer 11 and the second resin layer 31 of the first exemplary embodiment.

In the second exemplary embodiment, the pseudo sheet structure forming step is conducted as shown in FIGS. 3A and 3B. This pseudo sheet structure forming step is the same as the pseudo sheet structure forming step of the first exemplary embodiment except for using the above-described non-curable layer as the first resin layer 11.

In the second exemplary embodiment, the electrode attaching step is conducted as shown in FIG. 3C. This electrode attaching step is the same as the electrode attaching step of the first exemplary embodiment.

In the second exemplary embodiment, next, the second resin layer attaching step is conducted as shown in FIG. 3D. This second resin layer attaching step is the same as the second resin layer attaching step of the first exemplary embodiment except for attaching the second film 3 including the second resin layer 31.

In the second exemplary embodiment, the drying step is conducted subsequent to the second resin layer attaching step. This drying step is conducted in place of the curing step of the first exemplary embodiment. In the drying step, at least one of the first resin layer 11 or the second resin layer 31 is dried. In the second exemplary embodiment, due to the absence of a film or the like covering the second resin layer 31, at least one of the first resin layer 11 or the second resin layer 31 can be dried in the drying step.

Conditions of drying are not particularly limited, but can be set as needed according to the types of the resin composition and the solvent.

In the second exemplary embodiment, next, the process film 12 is released from the dried first resin layer 11 as shown in FIG. 3E. The method of releasing the process film 12 is the same as the process film release step of the first exemplary embodiment.

A sheet-shaped conductive member 100A can be thus manufactured.

### Effects of Second Exemplary Embodiment

The second exemplary embodiment can achieve effects similar to the effects (1) to (4) of the above first exemplary embodiment and the following effect (5′). (5′) By drying at least one of the first resin layer 11 or the second resin layer 31, the conductive linear bodies 21 can be protected. In a case where one of the first resin layer 11 and the second resin layer 31 is dried, the other thereof can be attached to an adherend as an adhesive layer.

### Third Exemplary Embodiment

Next, description will be made on a third exemplary embodiment of the invention with reference to the attached drawing.

The third exemplary embodiment is configured the same as the first exemplary embodiment except that the electrode attaching step is conducted as a step subsequent to the second resin layer attaching step. The second resin layer attaching step and the electrode attaching step are described, and the description of the rest common to the above is omitted.

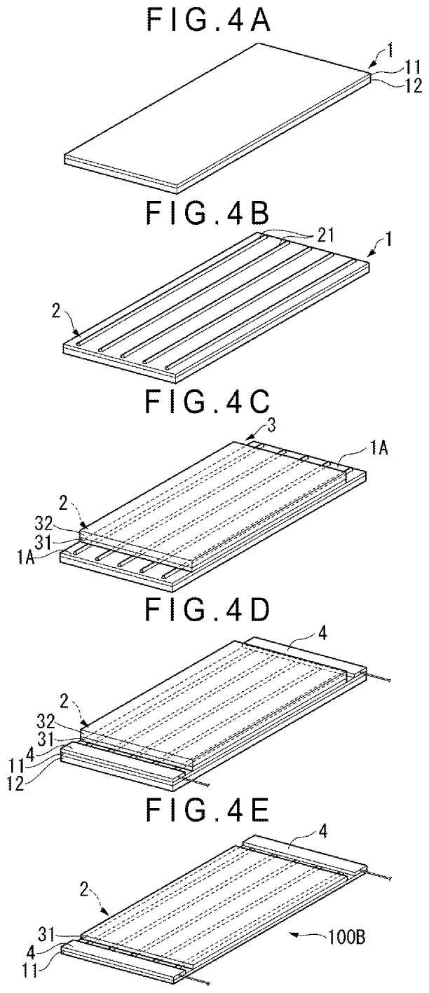

FIGS. 4A to 4E are illustrations for explaining a manufacturing method of a sheet-shaped conductive member according to the third exemplary embodiment.

In the third exemplary embodiment, the pseudo sheet structure forming step is conducted as shown in FIGS. 4A and 4B. This pseudo sheet structure forming step is the same as the pseudo sheet structure forming step of the first exemplary embodiment.

In the third exemplary embodiment, next, the second resin layer attaching step is conducted as shown in FIG. 4C. In the second resin layer attaching step, the second film 3 is attached to the first film 1 such that both ends of each of the conductive linear bodies 21 in the axial direction are not covered with the second film 3 as shown in FIG. 4C. Accordingly, parts 1A of the first film 1 are not covered with the second film 3.

In the third exemplary embodiment, the curing step is conducted subsequent to the second resin layer attaching step. This curing step is the same as the curing step of the first exemplary embodiment.

In the third exemplary embodiment, the electrode attaching step is conducted as shown in FIG. 4D. In the electrode attaching step, the electrodes 4 are attached to the corresponding parts 1A of the first film 1 which are not covered with the second film 3. A method of attaching the electrodes 4 is the same as the electrode attaching step of the first exemplary embodiment.

In the third exemplary embodiment, next, the process film release step is conducted as shown in FIG. 4E. This process film release step is the same as the process film release step of the first exemplary embodiment.

A sheet-shaped conductive member 100B can be thus manufactured.

### Effects of Third Exemplary Embodiment

This exemplary embodiment can achieve effects similar to the effects (1) and (3) to (5) of the first exemplary embodiment and the following effect (6).

(6) The electrodes 4 can be provided after the first resin layer 11 and the second resin layer 31 are attached. Accordingly, a timing of providing the electrodes 4 is not limited in the manufacture of the sheet-shaped conductive member 100B, whereby the sheet-shaped conductive member 100B is more freely designable.

### Modifications of Exemplary Embodiments

The scope of the invention is not limited to the above exemplary embodiments, and modifications, improvements, etc. are included within the scope of the invention as long as they are compatible with an object of the invention.

For instance, although the electrodes 4 are attached to the first film 1 in the above exemplary embodiments, the electrodes 4 are not necessarily attached. For instance, the sheet-shaped conductive member 100 does not necessarily include the electrodes 4. The electrodes 4 may be provided in advance to an article to be installed with the sheet-shaped conductive member, and the sheet-shaped conductive member 100 may be attached to the article such that the electrodes 4 are in contact with the pseudo sheet structure 2.

In the above exemplary embodiments, the process film release step is conducted in the manufacturing method of the sheet-shaped conductive member 100, but the timing of the process film release step is not limited thereto. For instance, the process film release step may be conducted by a user of the sheet-shaped conductive member 100 at the time of using the sheet-shaped conductive member 100.

### Usage of Sheet-Shaped Conductive Member

In a case where the sheet-shaped conductive member 100 is used as a heat-generating body (film heater), examples of the intended use of the heat-generating body include a defogger and a deicer. In this case, examples of the adherend include a mirror for a bathroom, etc., a window for a transportation device (a passenger vehicle, a train, a ship, an airplane, etc.), a window and wall paper for a building, an eyewear, a lighting surface of a traffic light, and a sign. In recent years, since a heater is used for controlling a temperature of a battery of an electric car, a thin heater is suitable for individually controlling a temperature of each of laminated cells. Further, the sheet-shaped conductive member of the invention also can be used as a flat cable for wiring an electric signal.

### Example(s)

The invention will be more specifically described with reference to Example(s).It should be noted that Example(s) are not intended to limit the scope of the invention. It should be noted that all the curable monomer, the polymerization initiator and the like in Example(s) and the like are described in terms of a solid content.

### Example 1

100 parts by mass of pellets of a polyimide resin (PI) (manufactured by Kawamura Sangyo Co., Ltd., trade name “KPI-MX300F”, Tg=354 degrees C.) was dissolved as a polymer component in a solvent (methyl ethyl ketone: a mixture solvent of MEK and toluene at a weight ratio of 1:1) to prepare a 15-mass% solution of PI. Next, to this solution, 220 parts by mass of dicyclopentadiene acrylate (manufactured by SHIN-NAKAMURA CHEMICAL Co., Ltd., trade name “A-DCP”) as the curable monomer and 4.4 parts by mass of bis(2,4,6-trimethylbenzoyl)-phenyl -phosphine oxide (manufactured by BASF, trade name “Irgacure819”) as the polymerization initiator were added and mixed to prepare a curable resin composition.

Next, a curable resin composition was coated on a process film (manufactured by LINTEC Corporation, trade name “SP-PET382150”). The obtained coated film was heated at 90 degrees C. for three minutes to dry the coated film, thereby forming a first resin layer. A release film (manufactured by LINTEC Corporation, trade name “SP-PET381130”) was attached to the formed resin layer to form a first film having a 10-μm-thick resin layer. A second resin layer was formed to prepare a second film in the same manner as the first film.

A tungsten wire (diameter: 14 μm, manufacturer name: TOKUSAI TungMoly Co., Ltd., product name: TGW-CS, hereinafter referred to as a “wire”) was prepared as a conductive linear body.

Next, the first film was creaselessly wound on a drum member having a rubber outer circumferential surface with the release film facing outward, and subsequently, both ends of the first film in the circumferential direction of the drum member were fixed by a double-sided tape. Subsequently, the release film was released to expose the first resin layer. After the wire wound on a bobbin was stuck on a surface of the first resin layer located near an end portion of the drum member, the wire was reeled on the drum member while being unwound and the drum member was moved little by little in a direction parallel with a drum axis, whereby the wire was helically wound on the drum member at equal intervals.

Thus, a plurality of wires were provided on the surface of the first resin layer while being spaced at a constant distance from adjacent ones, thereby forming the wire-provided first film. The wires were equidistant from each other at a 2.5-mm interval. The wire-provided first film was cut in parallel with the drum axis to manufacture the first film provided with the pseudo sheet structure. Next, a copper foil (10-μm thickness, 10-mm width) as each of the electrodes was placed on and attached to both ends pf the wires in a direction orthogonal to an extending direction of the wires, whereby the first film provided with the electrodes was obtained. Subsequently, the second film obtained after the release film was released therefrom was attached to the surface, on which the wires were disposed, of the first film provided with the electrodes.

Further, a belt conveyor-type ultraviolet irradiator (manufactured by EYE GRAPHICS CO., LTD., product name: ECS-401GX) was used for a curing reaction under conditions that, with a high-pressure mercury lamp (manufactured by EYE GRAPHICS CO., LTD., product name: H04-L41), an ultraviolet lamp height was 100 mm, an ultraviolet lamp output was 3 kw, an illuminance at a 365-nm wavelength of light was 400 mW/cm², and a light intensity was 800 mJ/cm², which were measured by an ultraviolet actinometer UV-351 manufactured by ORC MANUFACTURING CO., LTD. Subsequently, a process film was released to manufacture a sheet-shaped conductive member. A release force of the process film at this time was 50 mN/100 mm. A thickness of the obtained sheet-shaped conductive member was 22 μm.

### Resistance Value

A resistance value was measured by applying a tester on a part of the sheet-shaped conductive member corresponding the electrode. The sheet-shaped conductive member immediately after being manufactured (after being thermally cured) was energized for one hour at 10-V voltage, where the resistance value was measured. A change rate (%) of the resistance value was calculated according to the following equation.

change rate (%) of resistance value ={(resistance value of energized test piece)−(resistance value of test piece immediately after being manufactured)}/(resistance value of test piece immediately after being manufactured) ×100

The resistance value was evaluated in accordance with the following judgement criteria. The obtained results are shown in Table 1.The sheet-shaped conductive member becomes harder and exhibits higher freestanding property as the change rate of the resistance value becomes smaller, which indicates a favorable electric connection between the conductive linear bodies and the electrodes.

### Judgement Criteria

A: The change rate of the resistance value is less than 10%.

B: The change rate of the resistance value is 10% or more.

Storage Modulus at 25 Degrees C. Before Drying or Curing

The same composition as a composition forming a measurement target layer was coated or the like under the same conditions as in Examples or the like to manufacture a test piece A with 8-mm diameter×1-mm thickness. Under the following measurement conditions, a shear storage modulus G′ of the test piece A was measured by torsional shearing. The obtained value was defined as a storage modulus (unit: MPa) at 25 degrees C. The obtained results are shown in Table 1.

### Measurement Conditions

Measurement device: viscoelasticity measurement device (manufactured by Anton Paar GmbH, device name “MCR300”)

Test start temperature: −20 degrees C.

Test end temperature: 150 degrees C.

Heating rate: 3 degrees C. per minute

Frequency: 1 Hz

Measurement temperature: 25 degrees C.

Storage Modulus at 25 Degrees C. After Drying or Curing

The same composition as a composition forming a measurement target layer was cured or the like under the same conditions as in Examples or the like to manufacture a test piece B with 5-mm width×10-mm length×0.1-mm thickness. Under the following measurement conditions, a shear storage modulus G′ of the test piece B was measured in a tensile mode. The obtained value was defined as a storage modulus (unit: MPa) at 25 degrees C. The obtained results are shown in Table 1.

### Measurement Conditions

Measurement device: dynamic elastic modulus measurement device “DMA Q800” manufactured by TA instruments

Test start temperature: zero degrees C.

Test end temperature: 150 degrees C.

Heating rate: 3 degrees C. per minute

Frequency: 1 Hz

Amplitude: 5 μm

Measurement Temperature: 25 degrees C.

Rupture Stress

The sheet-shaped conductive member was cut into a test piece having 15-mm width×150-mm length (a longitudinal direction is a direction parallel with the wire). A distance between chucks was set at 100 mm in a tensile tester (Autograph manufactured by Shimadzu Corporation). Subsequently, the test piece was subjected to a tensile test at a speed of 200 mm/min to measure a rupture stress [N].

The obtained results are shown in Table 1.

TABLE 1

| | Resistance | Storage Modulus (MPa) | | Rapture |
|---|---|---|---|---|
| | Value | Before Curing | After Curing | Stress (N) |
| Example 1 | A | 0.03 | 2850 | 73 |

As shown by the results indicated in Table 1, it has been confirmed that the film heater obtained in Example 1 exhibits a small change rate of the resistance value and has the freestanding property in spite of having the thickness as thin as 22 μm. Moreover, it has been confirmed that the rapture stress is also high when the storage modulus of the resin layer is high as in Example 1.

What is claimed is:

1. A manufacturing method of a sheet-shaped conductive member, comprising:
providing a pseudo sheet structure to a first film, the pseudo sheet structure comprising a plurality of conductive linear bodies arranged at an interval therebetween, the first film comprising a process film and a first resin layer;
attaching a second film comprising a second resin layer to the first film with the second resin layer in contact with the pseudo sheet structure; and
drying or curing at least one of the first resin layer or the second resin layer.

2. The manufacturing method of the sheet-shaped conductive member according to claim 1, further comprising:
attaching electrodes to the pseudo sheet structure.

3. The manufacturing method of the sheet-shaped conductive member according to claim 1, wherein
the second film further comprises a process film.

4. The manufacturing method of the sheet-shaped conductive member according to claim 1, further comprising:
releasing the process film from at least one of the dried or cured first resin layer or second resin layer.

5. The manufacturing method of the sheet-shaped conductive member according to claim 4, wherein
a release force of the process film is in a range from 5 mN/100 mm to 2000 mN/100 mm.

6. The manufacturing method of the sheet-shaped conductive member according to claim 1, wherein
at least one of the first resin layer or the second resin layer is energy-ray-curable.

7. The manufacturing method of the sheet-shaped conductive member according to claim 1, wherein
both of the first resin layer and the second resin layer are energy-ray-curable.

8. The manufacturing method of the sheet-shaped conductive member according to claim 1, wherein
a total thickness of a thickness of the first resin layer and a thickness of the second resin layer is in a range from 7 μm to 500 μm.

9. A sheet-shaped conductive member comprising:
a first resin layer;
a second resin layer; and
a pseudo sheet structure interposed between the first resin layer and the second resin layer and comprising a plurality of conductive linear bodies arranged at an interval therebetween, wherein
a thickness of the sheet-shaped conductive member is in a range from 7 μm to 200 μm, and
at least one of the first resin layer or the second resin layer has a storage modulus in a range from 5×10⁷ Pa to 5.0×10¹⁰ Pa at a temperature of 25 degrees C.
